(19) United States
(12) Patent Application Publication
(10) Pub. No.: US 2010/0100991 A1
(43) Pub. Date: Apr. 22, 2010

(54) Charge-Amp Based Piezoelectric Charge Microscopy (CPCM) Reading of Ferroelectric Bit Charge Signal

(75) Inventors: Byong M. Kim, Fremont, CA (US); Robert N. Stark, Saratoga, CA (US); Quan Tran, Fremont, CA (US); Wade Hassler, Aromas, CA (US); Qing Ma, San Jose, CA (US); Donald E. Adams, Pleasanton, CA (US); Yevgeny V. Anoikin, Fremont, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/254,636

(22) Filed: Oct. 20, 2008

(51) Int. Cl. G01N 27/00

(52) U.S. Cl. 850/62

(57) ABSTRACT

A device to detect polarization of a ferroelectric material comprises a probe tip, a charge amplifier electrically connected with the probe tip to convert a charge coupled to the probe tip from the ferroelectric material into an output voltage. The ferroelectric material is oscillated at a reference signal so that a charge is coupled to the probe tip and converted to an output voltage by the charge amplifier. A lock-in amplifier that receives the reference voltage and applies the reference voltage to the output voltage to extract a signal output representing the polarization.

### BACKGROUND

Piezoelectricity converts mechanical energy to electrical energy providing a mechanism useful in applications relying on micro-technology. Piezoelectric-based transducers are ubiquitous in products ranging from household appliances to advanced consumer products to sophisticated scientific instruments and industrial tools. Understanding the piezoelectric properties of piezoelectric-based transducers at the molecular level can benefit the design of such transducers and can improve the efficiency in manufacturing such transducers.

Further, ferroelectric films have been proposed as promising recording media, with a bit state corresponding to a spontaneous polarization direction of the media, wherein the spontaneous polarization direction is controllable by way of application of an electric field. Understanding the piezoelectric response of a ferroelectric film can enable detection of the spontaneous polarization direction of the ferroelectric film.

### BRIEF DESCRIPTION OF THE DRAWINGS

Further details of the present invention are explained with the help of the attached drawings in which:

FIG. 1A is a simplified perspective view of a set-up for applying scanning probe microscopy techniques to determine polarization of a ferroelectric material.

FIG. 1B illustrates the piezoresponse of a ferroelectric material in response to the application of an electric field to the ferroelectric material.

FIG. 2 is a simplified side view of an embodiment of a system for applying a Piezoresponse Force Microscopy (PFM) technique to a ferroelectric material.

FIG. 3A is an oscilloscope trace displaying experimental data generated by an embodiment of a method and system in accordance with the present invention applied to a sample comprising a ferroelectric material.

FIG. 3B is a trace displaying experimental data generated by applying scanning probe microscopy techniques to the sample.

FIG. 4 is a cross-sectional side view of an information storage device for applying embodiments of methods and systems in accordance with the present invention, the information storage device including a plurality of tips extending from corresponding cantilevers toward a movable media.

### DETAILED DESCRIPTION

Piezoresponse Force Microscopy (PFM) is a scanning probe microscopy technique enabling measurement and characterization of piezoelectric behavior of ferroelectric materials on the nanometer and sub-nanometer scale. All ferroelectrics are also piezoelectric. A ferroelectric material's piezoresponse is the mechanical response of the material when an electric field is applied to the material. A ferroelectric material expands when an electric field parallel to the material's polarization is applied and contracts when an electric field anti-parallel to the material's polarization is applied. PFM uses a tip to probe a ferroelectric material's mechanical response to an applied electric field, measuring the electromechanical response of individual nanometer-scale grains of the ferroelectric material. PFM techniques have been shown to delineate regions of different piezoresponse with sub-nanometer lateral resolution. The tip is usually made of, or is coated with, a conductive material to enhance the electrical contact between the tip and the sample. The tip is placed in contact with the ferroelectric material and the piezoresponse is measured from the deflection of a cantilever from which the tip extends. The piezoresponse can be made to oscillate when a small ac modulation is added to the applied field.

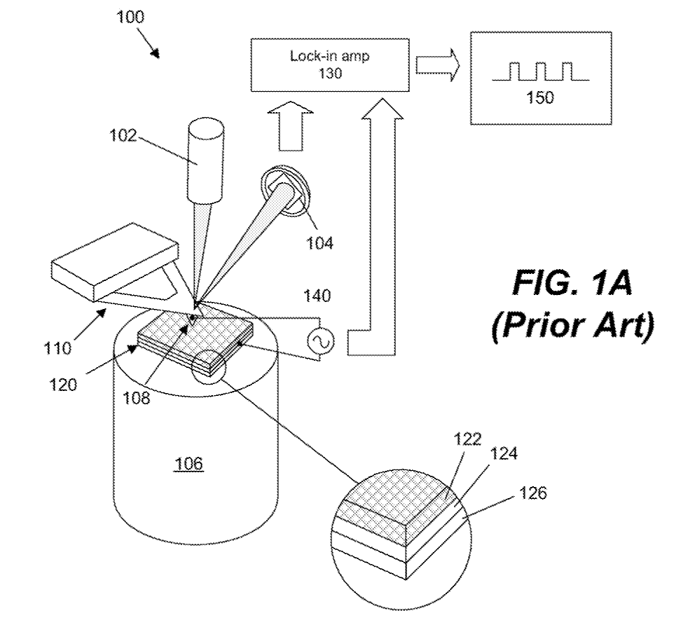

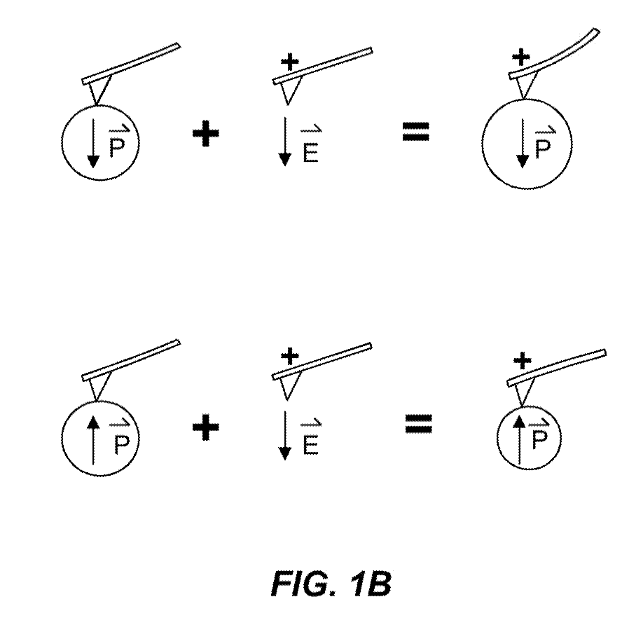

FIG. 1A illustrates a set-up 100 for applying a PFM technique to a sample 120 mounted on a stage 106 and comprising a ferroelectric material 122 formed over a ground plane 124 and substrate 126. The set-up includes a tip 108 extending from a cantilever 110 and placed in contact with the ferroelectric material 122. A laser 102 directs a beam at the cantilever, preferably near a portion of the cantilever 110 opposite the tip 108. The laser beam is reflected onto a position sensitive photodetector 104. An ac voltage is applied by a voltage source 140 between the tip 108 and the ground plane 124 and across the ferroelectric material 122. The expansion and contraction (i.e., the piezoresponse) of the ferroelectric material 122 (as shown in FIG. 1B) is measured from the deflection of the cantilever 110 and detected by the position sensitive photodetector 104. The deflection measurement uses a lock-in amplifier 130 to extract a signal 150 corresponding to polarization.

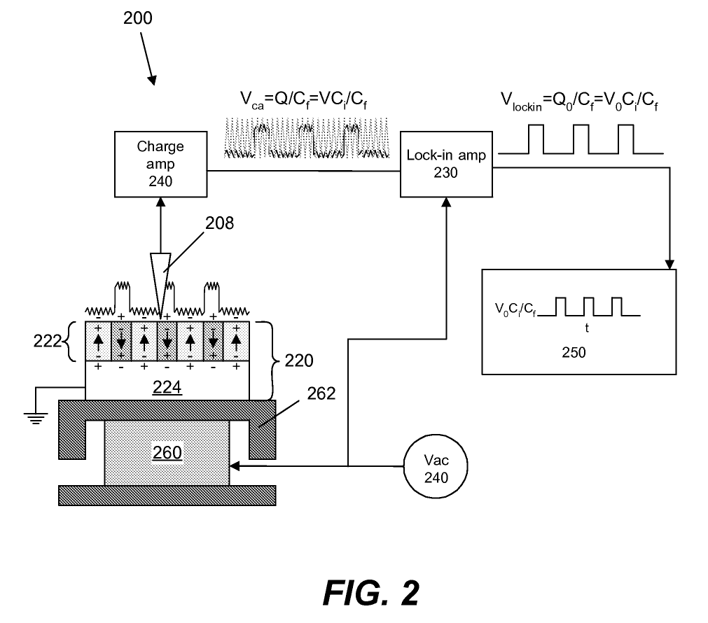

Referring to FIG. 2, an embodiment of a method and system 200 to detect the piezoresponse of a ferroelectric material 222 in accordance with the present invention is shown. A sample 220 comprises the ferroelectric material 222 formed on a conductive layer 224 that provides a ground plane. As shown, the sample 220 is mounted to a shield 262 that electrically isolates the sample 220. In other embodiments, the sample can comprise a substrate on which the conductive layer 224 is formed. A conductive probe tip (referred to hereinafter as a tip) 208 is placed in contact with the ferroelectric material 222 and the sample 220 is vibrated against the tip 208 by a piezo-vibrator 260 connected with the shield 262. An AC voltage, V_{ac}, is applied to the piezo-vibrator 260 by a voltage source to oscillate the shield 262—and by extension the ferroelectric material 222—at a reference frequency. The out-of-plane motion of the ferroelectric material 222 when in contact with the tip 208 generates an alternating piezoelectric charge response at the interface of the tip 208 and ferroelectric material 222. The tip 208 is electrically connected with a charge-amp allowing the system to detect a charge signal, Q, by converting a charge coupled to the tip 208 from the ferroelectric material 222 into an output voltage, V_{ca}. The charge-amp converts the charge, Q, detected by the tip 208 to a voltage according to the relationship V_{ca}=Q/C_{f}, where 1/C_{f}=1/0.5 pf is charge-amp gain. The charge-amp output voltage, V_{ca}, is typically a noisy signal that includes bit charge (Q₀), alternating piezoelectric charge, and stray charge responses picked up by the tip 208. A lock-in amplifier 230 receives the AC voltage and applies the AC voltage as a reference to extract a signal output, V_{lockin}, 250 that varies with a polarization of a portion of the ferroelectric material 222 proximate to the tip 208. The lock-in amplifier 230 singles out the charge-amp output voltage, V_{ca}, at the reference frequency to a highly clean DC voltage signal output having a relationship to bit charge V_{lockin}=V₀Cᵢ/C_{f}=Q₀Cᵢ where V₀ is a surface potential and Cᵢ˜0.5 pf is experimentally determined value of input capacitance. As shown, an oscilloscope records the surface potential (V₀=Q₀/Cᵢ) profile that reflects the bit charge (Q₀) distribution on the media surface in time domain. However, alternatively the signal output can be received by a device other than an oscilloscope so that the signal output can be recorded, displayed, analyzed, and/or otherwise processed. Embodiments of methods and systems in accordance with the present invention comprising a charge-amplifier and lock-in amplifier to resolve bit charge distribution on a ferroelectric media are also referred to as charge-amp based charge piezoelectric charge microscopy, or CPCM.

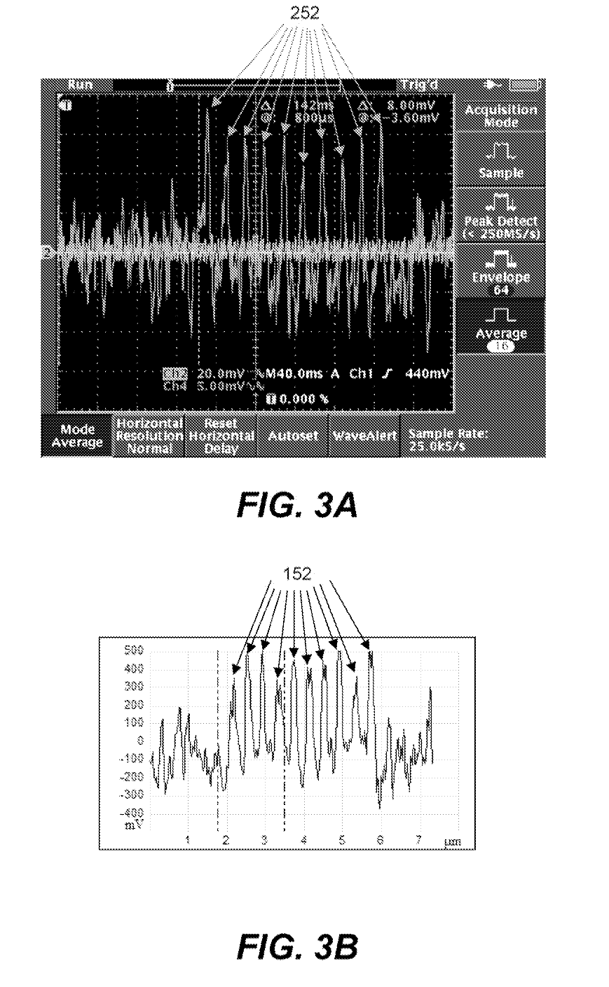

FIG. 3A is an oscilloscope trace displaying experimental data generated by scanning the surface of a sample of ferroelectric material vibrated out-of-plane using an embodiment of a method and system in accordance with the present invention. The sample comprises a ferroelectric recording layer of lead zirconate titanate (PZT) formed over a bottom electrode of strontium ruthenate (SRO). The experimental data displayed is the bit charge signal profile in the time domain. The trace corresponds to ten cycles 252 of 80 nm width and 400 nm wavelength bits of down polarizations written over an up-polarization background by applying −9.5 V pulse trains of 1 μs width and 20 ms period to the SRO electrode while scanning the tip loaded with a contact force in the range of 100 nN at a speed of 20 μm/s. To generate the experimental data, the tip was loaded with a contact force in the range of 100 nN and scanned across the bits at a speed of 20 μm/s while a 503 kHz, 1.7 Vₚₚ signal was continuously applied to the piezo-vibrator to oscillate the media.

FIG. 3B is a trace showing experimental data generated by scanning the surface of the sample using a PFM technique. The experimental data displayed is the response in distance domain of the same ten cycles 152 of bits as shown in the oscilloscope trace of FIG. 3A. To generate the experimental data, the tip was loaded with a contact force in the range of 100 nN and scanned across the bits at a speed of 20 μm/s while a 267 kHz, 0.6 Vₚₚ sine wave was continuously applied to the SRO electrode to oscillate the media. Both CPCM, which comprises a charge-amp based technique, and PFM, which comprises an optical detection based technique, resolve the 80 nm bits. However, the detection circuit of CPCM can be realized using standard semiconductor fabrication techniques, simplifying very-large-scale integration (VLSI) of such structures into applications that include microelectromechanical systems (MEMS) relative to the structures required for PFM.

Still further, embodiments of CPCM systems and methods in accordance with the present invention can potentially provide improved performance over other techniques that can be realized using VLSI fabrication techniques. One technique for detecting domain polarization in a ferroelectric recording layer is described by Tran et al. in U.S. Ser. No. 11/964,580 entitled “ARRANGEMENT AND METHOD TO PERFORM SCANNING READOUT OF FERROELECTRIC BIT CHARGES,” incorporated herein by reference. The technique described by Tran et al. relies on a current-amplifier to detect domain polarization. Embodiments of CPCM systems and methods in accordance with the present invention rely on a charge-amplifier for polarization detection and can enable faster signal detection. Faster signal detection enables bit reading with a higher signal-to-noise ratio (SNR). A higher SNR can permit polarization detection to be achieved with a lower contact force between the tip and the media, potentially improving tip and/or media longevity, for example where tip wear over extended tip-scanning read/write cycles is a relevant concern.

Embodiments of systems and methods in accordance with the present invention comprise detecting a charge signal in a vibrating media using a synchronous demodulation technique. The embodiment shown in FIG. 2 and described above comprises a piezo-vibrator that vibrates a media (e.g., the sample) to induce force modulation at the interface of the tip and the ferroelectric material. However, in alternative embodiments of methods and system in accordance with the present invention, a media can be vibrated by way of a device or technique other than a piezo-vibrator. For example, in an embodiment, a media (and more particularly the ferroelectric material) can be vibrated by surface acoustic waves. In an alternative embodiment, a piezo-layer can be embedded in the media itself (e.g., between a substrate and an insulating layer that electrically isolates a ferroelectric layer) enabling the media to be vibrated upon application of a signal to the piezo-layer. In still other embodiments, some other movement mechanism and/or technique can be associated with the media for inducing vibration. For example, the media can be vibrated using electrostatic or electromagnetic structures for movement. One of ordinary skill in the art, upon reflecting on the teachings included herein, will appreciate the myriad different techniques and structures, many capable of miniaturization, with which a media can be vibrated to induce force modulation at a media-tip interface. The present invention is not intended to be limited to systems and methods comprising a piezo-vibrator.

Embodiments of systems and methods in accordance with the present invention can be applied in information storage devices enabling potentially higher density storage relative to current ferromagnetic and solid state storage technology. Such information storage devices can include nanometer-scale heads, contact probe tips and the like capable of one or both of reading and writing to a media. High density information storage devices can include seek-and-scan probe (SSP) memory devices comprising cantilevers from which tips extend for communicating with a media using scanning-probe techniques. The cantilevers and tips can be implemented in a micro-electromechanical system (MEMS) and/or nano-electromechanical system (NEMS) device with a plurality of read-write channels working in parallel.

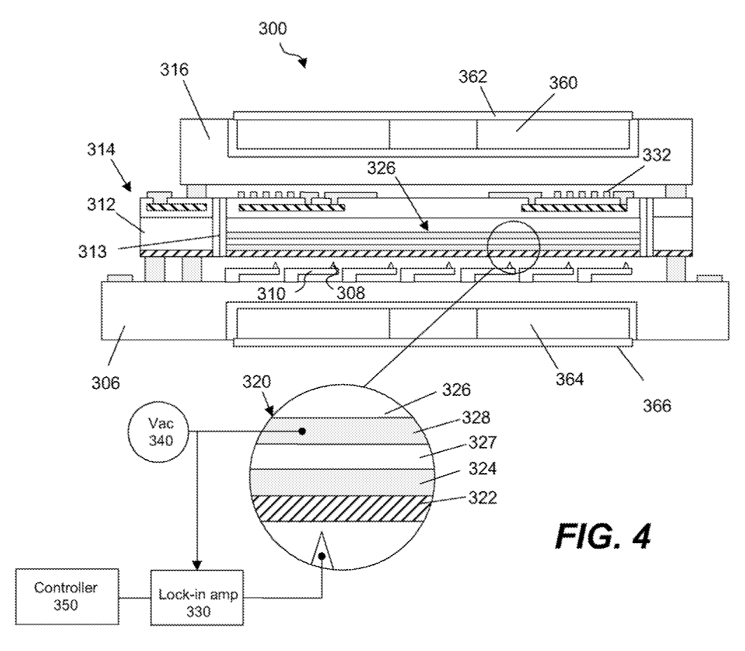

FIG. 4 is a simplified cross-section of a system for storing information (also referred to herein as a memory device) 300 comprising a tip substrate 306 arranged substantially parallel to a media 320 disposed on a media platform 326. A cap 316 can be bonded with a media substrate 314 and the media substrate 314 can be bonded with the tip substrate 306 to seal the media platform 326 within a cavity between the cap 316 and tip substrate 306. Cantilevers 310 extend from the tip substrate 306, and tips 308 extend from respective cantilevers 310 toward the surface of the media 320. The media 320 includes a ferroelectric recording layer 322, a conductive layer 324, an insulating layer 327, and a piezo-layer 328 formed on the media platform 326.

The media substrate 314 comprises the media platform 326 suspended within a frame 312 by a plurality of suspension structures (e.g., flexures) 313, for example as described in U.S. Ser. No. 11/553,435, entitled “Memory Stage for a Probe Storage Device,” incorporated herein by reference. The media platform 326 can be urged in a Cartesian plane within the frame 312 by electromagnetic motors comprising electrical traces 332 (also referred to herein as coils, although the electrical traces need not consist of closed loops) placed in a magnetic field so that controlled movement of the media platform 326 can be achieved when current is applied to the electrical traces 332. The media platform 326 is urged by taking advantage of Lorentz forces generated from current flowing in the coils 332 when a magnetic field perpendicular to the Cartesian plane is applied across the coil current path. A magnetic field is generated outside of the media platform 326 by a first permanent magnet 360 and second permanent magnet 364 arranged so that the permanent magnets 360,364 roughly map the range of movement of the coils 332. The permanent magnets 360,364 can be fixedly connected with a rigid or semi-rigid structure such as a flux plate 362,366 formed from steel, or some other material for acting as a magnetic flux return path and containing magnetic flux. Alternatively, a single magnet can be used to generate the magnetic field between two flux plates.

Embodiments of systems and methods in accordance with the present invention comprise determining ferroelectric polarization using CPCM techniques. A charge signal can be detected by placing the tip 308 in contact or near contact with the ferroelectric recording layer 322 and vibrating the ferroelectric recording layer 322 by applying a time-varying signal to the piezo-layer 328 electrically isolated from the ferroelectric layer 322 by the insulating layer 327. The time-varying piezo-response of the piezo-layer will cause the ferroelectric recording layer 322 to vibrate against the tip 308. As above, the tip 308 is electrically connected with a charge-amp 340 allowing the system to detect a charge signal. A lock-in amplifier 330 receives the time-varying voltage applied to the piezo-layer and applies the time-varying voltage as a reference to extract a signal output that varies with a polarization of a portion of the ferroelectric material 322 proximate to the tip 308. A controller 350 can receive the signal output and reply to a data request from a host, for example.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A device to detect polarization of a ferroelectric material comprising:
a probe tip;
a charge amplifier electrically connected with the probe tip to convert a charge coupled to the probe tip from the ferroelectric material into an output voltage;
a first structure to oscillate the ferroelectric material;
a voltage source to apply a reference voltage to the structure so that the ferroelectric material is oscillated at a reference frequency; and
a second structure that receives the reference voltage and applies the reference voltage to the output voltage to extract a signal output representing the polarization.

2. The device of claim 1, wherein the first structure to vibrate the ferroelectric material is a piezo-vibrator and the second structure is a lock-in amplifier.

3. The device of claim 2, further comprising a stage on which the ferroelectric material is mountable, wherein the stage is connected with the piezo-vibrator.

4. The device of claim 1 further comprising an oscilloscope to display the signal output representing the polarization.

5. The device of claim 1, further comprising:
a mover;
wherein the probe tip is connected with the mover; and
wherein the probe tip is movable relative to the ferroelectric material by way of the mover.

6. The device of claim 1, further comprising:
a mover;
wherein the stage is associated with the mover; and
wherein the stage is movable relative to the probe tip by way of the mover.

7. The device of claim 3, wherein:
the stage further includes a shield arranged between the piezo-vibrator and the ferroelectric material; and
the ferroelectric material is mountable to the shield by way of an adhesive.

8. The device of claim 1, further comprising a processor to execute a program utilizing the signal output.

9. A method to detect polarization of a ferroelectric material comprising:
positioning a probe tip in contact with the ferroelectric material, the probe tip being electrically connected with a charge amplifier;
oscillating the ferroelectric material at a reference signal so that a charge is coupled to the probe tip and converted to an output voltage by the charge amplifier;
receiving the output voltage in a lock-in amplifier;
receiving the reference signal in the lock-in amplifier; and
generating a signal output representing the polarization with the lock-in amplifier.

10. The method of claim 9, further comprising;
receiving the ferroelectric material on a stage connected with a piezo-vibrator; and
wherein oscillating the ferroelectric material further includes applying a reference signal to the piezo-vibrator so that a charge is coupled to the probe tip and converted to an output voltage by the charge amplifier.

11. The method of claim 9, wherein the signal output is received by an oscilloscope and further comprising:
displaying the signal output on a screen of the oscilloscope.

12. The method of claim 9, further comprising:
associating the signal output with a datum; and
wherein the association is bidirectional.

13. The method of claim 9, further comprising:
moving one or both of the stage and the probe tip;
associating the signal output with data; and
wherein associating a datum of the data is bidirectional.

14. The method of claim 9, wherein the signal output is displayed on a computer screen.

15. The method of claim 9, further comprising manipulating the signal output using a processor.

16. A device to detect polarization of a ferroelectric material comprising:
a probe tip;
a charge amplifier electrically connected with the probe tip to convert a charge coupled to the probe tip from the ferroelectric material into an output voltage;
a mechanism to oscillate the ferroelectric material at a reference frequency.

17. The device of claim 16, wherein the mechanism is an acoustic wave generator adapted to generate acoustic waves on the surface of the ferroelectric material.

18. The device of claim 16, wherein the mechanism is a piezo-vibrator connected with a stage on which the ferroelectric material is mounted and a voltage source that applies a reference voltage to the piezo-vibrator.

19. The device of claim 16, wherein:
a media comprises the ferroelectric material formed over a piezo-layer and the mechanism is the piezo-layer; and
the piezo-layer is electrically insulated from the ferroelectric material.

20. The device of claim 16, further comprising
a structure that receives a reference voltage having the reference frequency and applies the reference voltage to the output voltage to extract a signal output representing the polarization.

21. The device of claim 20, wherein the structure is a lock-in amplifier.
